(19) United States
(12) Patent Application Publication
(10) Pub. No.: US 2025/0004927 A1
(43) Pub. Date: Jan. 2, 2025

(54) TEST CASES SATISFYING CONSTRAINTS USING NATURAL LANGUAGE

(71) Applicant: International Business Machines Corporation, Armonk, NY (US)

(72) Inventors: Saswati Dana, Bangalore (IN); Dinesh Khandelwal, Indore (IN); Varad Bhatnagar, Bangalore (IN); Dinesh Garg, Beawar (IN); Amar Prakash Azad, Bangalore (IN)

(21) Appl. No.: 18/343,100

(22) Filed: Jun. 28, 2023

(51) Int. Cl. G06F 11/36

(52) U.S. Cl. CPC G06F 11/3684; G06F 11/3676

(57) ABSTRACT

Test cases are generated satisfying constraints from natural language descriptions in code by parsing source code to extract variables, and extracting constraints from a natural language description in the source code to retrieve boundary conditions on the variables. Mapping between the variables extracted from the source code and the constraints from the natural language description; and generating input variables satisfying the constraints provided from the natural language description. The method may further include executing the source code using the input variables satisfying the constraints provided from the natural language description.

### BACKGROUND

The present invention generally relates to electrical component manufacturing using automation technology controlled using computer software, for example using robotic technology.

Code translation is an area of research where one can translate code written in obsolete languages to contemporary/latest state-of-the art languages. Measuring performance accuracy in code translation task is important to judge/measure the quality of translation. The performance accuracy can be measured in terms of number of test cases the translated codes pass. This task can be performed once we have a sufficient number of the input-output pair for a given data (code). Motivated by this we propose a system and method that can automatically generates n number of test inputs and outputs.

### SUMMARY

In accordance with some embodiments of the present disclosure, computer implemented methods, systems and computer program products have been provided for automatically generating test cases satisfying constraints on program input specified via natural language. A two-step approach is provided for automatically generating (n) number of test input/output pairs. In the first step, the computer implemented method can parse the code and get the tokens of code as a list. Then by pattern matching and applying rules, the methods can extract the variables which takes inputs from keyboard. The method can also determine their types. In the second step, the method can extract the boundary conditions of the variables from natural language constraints. The method can then map the variables extracted from each step mentioned above. Thereafter, by employing a random generator, the method can generate inputs and executing the gold Java programs on these inputs we get outputs.

In one aspect, a computer implemented method is provided for generating test cases satisfying constraints using natural language. In one embodiment, the computer implemented method includes parsing code to extract variables and types; and extracting constraints from a natural language description in the code to get boundary conditions on the variables. The method may continue with mapping between the variables extracted from code and the constraint from the natural language description. The method may continue with generating input variables satisfying the constraints provided from the natural language description. An output is generated by executing the source code using the input variables satisfying the constraints provided from the natural language description.

In another aspect, a system is provided for generating test cases satisfying constraints using natural language. In one embodiment, the system can for generating test cases satisfying constraints includes a hardware processor; and a memory that stores a computer program product. The computer program product when executed by the hardware processor, causes the hardware processor to parse source code to extract variables; and extract constraints from a natural language description in the source code to get boundary conditions on the variables. The system can map between the variables extracted from the source code and the constraints from the natural language description. The system can also generate input variables satisfying the constraints provided from the natural language description; and execute the source code using the input variables satisfying the constraints provided from the natural language description.

In yet another aspect, the present disclosure describes a computer program product for generating test cases satisfying constraints using natural language. The computer program product can include a computer readable storage medium having computer readable program code embodied therewith. The program instructions executable by a processor to cause the processor to extract variables; and extract constraints from a natural language description in the source code to get boundary conditions on the variables. The computer program product can also map, using the hardware processor, between the variables extracted from the source code and the constraints from the natural language description. The computer program product can also generate, using the hardware processor, input variables satisfying the constraints provided from the natural language description; and execute the source code using the input variables satisfying the constraints provided from the natural language description.

### BRIEF DESCRIPTION OF THE DRAWINGS

The following description will provide details of preferred embodiments with reference to the following figures wherein:

FIG. 1 is a flow/block diagram illustrating one embodiment of an example environment for generating test cases satisfying constraints using natural language.

FIG. 2 is a flow/block diagram showing a computer implemented method for generating test cases satisfying constraints using natural language, in accordance with one embodiment of the present disclosure.

FIG. 3 is a flow/bock diagram illustrating one example of extracting the input variables and their types from the source code, in accordance with one embodiment of the present disclosure.

FIG. 4 is a generalized diagram of a neural network, in accordance with one embodiment of the present disclosure.

FIG. 5 is a flow/block diagram illustrating extracting the boundary conditions from natural language constraints, in accordance with one embodiment of the present disclosure.

FIG. 6 is a flow/block diagram illustrating employing a mapper to parse the outputs from the step of extracting input variables and their types from the source code as illustrated in FIG. 3; and employing a mapper to parse the outputs from the step of extracting boundary conditions from natural language in FIG. 5, as well as input and output generation, in accordance with one embodiment of the present disclosure.

FIG. 7 is a flow/block diagram illustrating a system generating test cases satisfying constraints using natural language, in accordance with one embodiment of the present disclosure.

FIG. 8 is a block diagram illustrating a system that can incorporate the system generating test cases satisfying constraints using natural language that is depicted in FIG. 3, in accordance with one embodiment of the present disclosure.

FIG. 9 depicts a computing environment according to an embodiment of the present disclosure.

### DETAILED DESCRIPTION

The methods, systems, and computer program products described herein can provide for automatically generating test cases satisfying constraints on program input specified via natural language.

The methods, systems and computer program products are related to an important challenge faced by the practitioners while leveraging any artificial intelligence (AI) technique to automatically translate a given computer program, e.g., first program language, such as COBOL, into an equivalent computer program written into another programming language, e.g., second program language, such as JAVA. The challenge faced by the practitioners is how to verify whether the translated program by the AI method is functionally equivalent to the original COBOL program. A standard technique to solve such a problem is the use of unit-test-cases where each unit-test-case is an input-output pair capturing expected behavioral trait of the program. The major challenge here is the general lack of availability of test-cases for such programs.

Tools exist for automatically generating unit-test-cases for a given JAVA program, but the behavior of the translated Java program needs to be verified against the behavior of the original COBOL program. This is a feature not provided by existing methods. In some examples, the information about the behavior of the original COBOL program is made available via natural language description. However, it has been determined that methods of unit-test-cases presently generated existing tools do not look at, or consider, the natural language description (or doc string) available with the original COBOL code, while generating unit-test-cases for the translated JAVA program. Therefore, there is no guarantee if the generated unit-test-cases by any such tool would capture the desired behavioral traits of the translated JAVA program. Because of this, most of the generated unit-test-cases by such tools that do not read behavior information are either invalid or useless for checking behavior equivalence of the translated JAVA program.

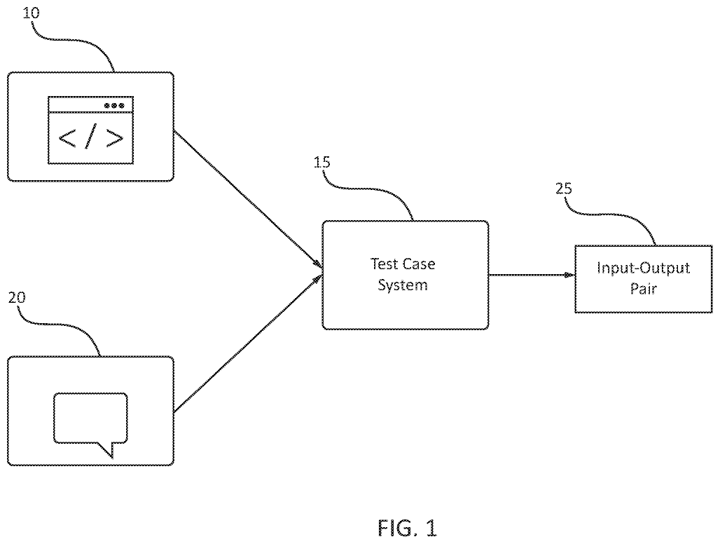

In light of the above, the methods, systems and computer programs of the present disclosure propose a system and method which that takes a natural language description of the semantic behavior of the source program, and a JAVA program, and then it automatically generates ‘k’ (k may be said 5, 10, or 20 . . . as user wants) number of input-output pairs that satisfy the semantic constraints specified in the natural language. The methods, systems and computer program products of the present disclosure are now described in greater detail with reference to FIGS. 1-8.

FIG. 1 is a flow/block diagram illustrating one embodiment of an example environment for generating test cases satisfying constraints using natural language. FIG. 1 illustrates input-output pair generation tasks. Code in a specific programming language at block 10 is fed into the system generating test cases 100 satisfying constraints using natural language at block 15. In this example, the code may be in the COBOL. “COBOL” is a type of computing code that split into four divisions, e.g., (identification, environment, data, and procedure, containing a rigid hierarchy of sections, paragraphs and sentences. It is noted that the example depicted in FIG. 1 illustrates only one example of the present disclosure. Other computing languages may be also be employed for the input.

It is noted that the computer language selected for the code has information about the behavior of the original program that is made available using natural language description. At block 20, a problem definition is also fed into the system generating test cases 100 satisfying constraints using natural language at block 15. The problem definition may be in natural language along with the boundary condition/constraint. Boundary conditions most often apply to the data processed by a program. A constraint is a relation between multiple variables which limits the values these variables can take simultaneously.

For example, the natural language description may be provided by a doc string (“docstring”). In programming, a “docstring” is a string literal specified in source code that is used, like a comment, to document a specific segment of code. Unlike conventional source code comments, or even specifically formatted comments like docblocks, docstrings are not stripped from the source tree when it is parsed and are retained throughout the runtime of the program. This allows the programmer to inspect these comments at run time, for instance as an interactive help system, or as metadata.

Still referring to FIG. 1, from the code at block 10 and the program definition at block 20, the proposed system at block 15 provides an input-output pair at block 25. The input-output pair at block 25 are testcases satisfying constraints on program input specified via natural language.

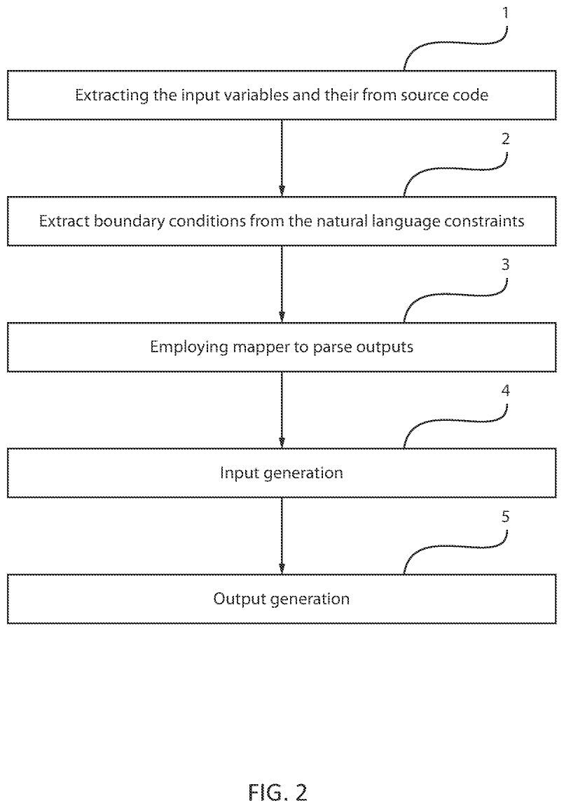

FIG. 2 is a flow/block diagram showing a computer implemented method for generating test cases satisfying constraints using natural language, in accordance with one embodiment of the present disclosure. The method depicted in FIG. 2 takes a natural language problem statement and a Java program as input and outputs ‘k’ number of input-output pairs.

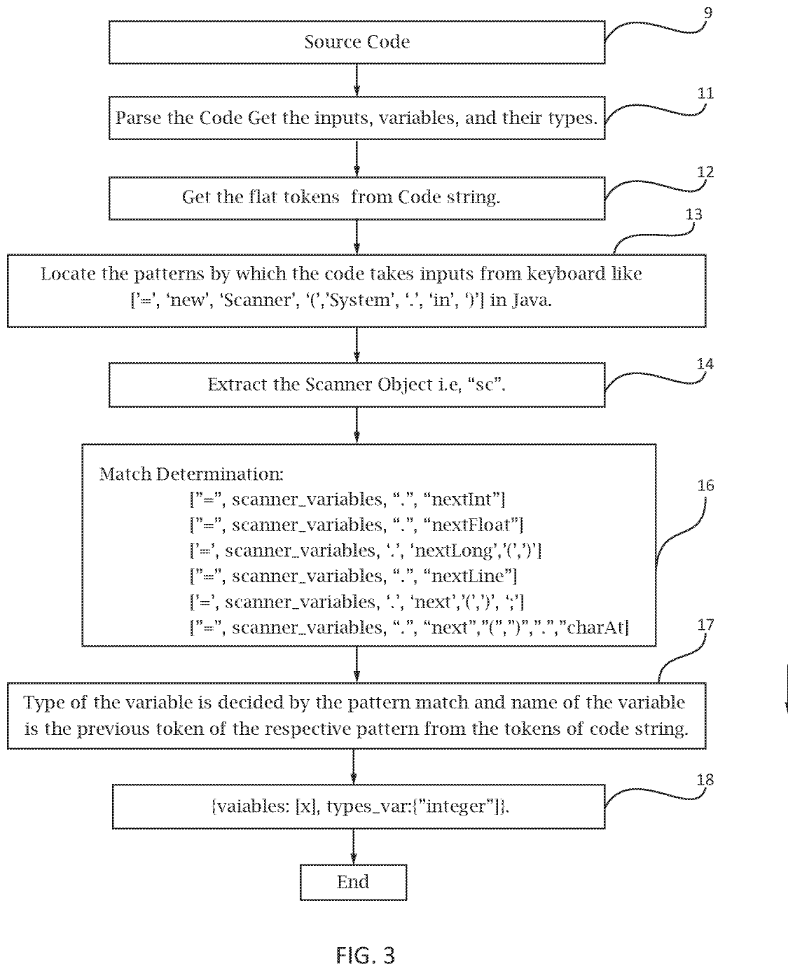

Referring to block 1, the computer implemented method may include extracting the input variables and their types from source code by either: (a) a rule-based method; (b) neural based method; or (c) program analysis-based method. The rule-based method may include three steps. For example, referring to FIG. 3, in a first step, the code at block 9 may be parsed through a tree-sitter at block 11. A tree sitter is a parser generator tool and an incremental parsing library. It enables you to generate concrete syntax tree from any language it supports. Following the code being parsed, flat tokens of the code are then extracted at block 12 of FIG. 3. A programming token is the basic component of source code. Characters are categorized as one of five classes of tokens that describe their functions (constants, identifiers, operators, reserved words, and separators) in accordance with the rules of the programming language. At block 13 of FIG. 3, the method may continue with locating the pattern which the code takes inputs from. Next, in a second step, the scanner object for the specific code is determined. In Java, Scanner is a class in java.util package used for obtaining the input of the primitive types like int, double, etc. and strings. For example, if there is “Scanner sc=new Scanner (System.in)” in the code the scanner object is “sc”. This step is illustrated in block 14 of FIG. 3.

In some examples, from the above information about scanner object and parsed code the third step of the rule based method is to find the variable name and it's type by searching (by regular expression matching) any possible pattern as following in the code. Regular expression matching allows for to test whether a string fits into a specific syntactic shape. Regular expression matching, can further allow for a search a string for a substring that fits a pattern. A regular expression describes a set of strings.

Taking the following code as an example:

[“=”, sc, “.”, “nextInt”] (a)

[“=”, sc, “.”, “nextFloat”] (b)

[‘=’, sc, “.”, ‘nextLong’, ‘(‘,’)’] (c)

[“=”, sc, “.”, “nextLine”] (d)

[‘=’, sc, ‘.’, ‘next’, ‘(‘,’)’, ‘;’] (e)

[“=”,sc, “.”, “next”, “(”,“)”, “.”, “charAt”] (f)

For example, referring to block 16 of FIG. 3, in the code if there is a line as below: int x =sc.nextInt() a determination is made if it matches the pattern (a) above. If there is a match at block 17 of FIG. 3, it can be concluded that the type of variable is “integer” and name of the variable is x by pattern matching at block 18 of FIG. 3. In this example, all the variables and their types can be determined by above three described steps.

In some other embodiments, to extract the input variables and their types the method may employ a neural based approach. The neural based approach can include starting with training data for a given program in JAVA and corresponding input types for that code, and finetuning a neural model, e.g., GTP based.

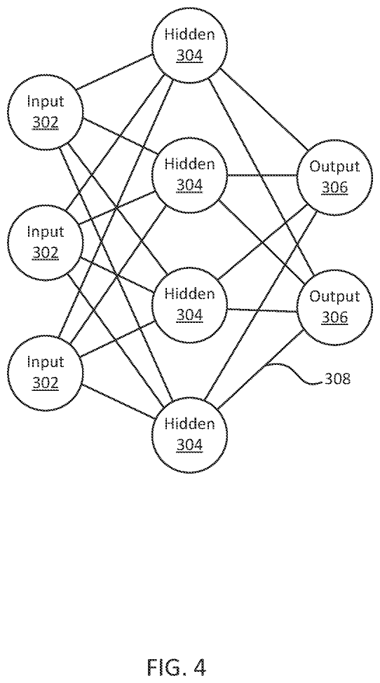

FIG. 4 is a generalized diagram of a neural network, in accordance with one embodiment of the present disclosure. An artificial neural network (ANN) is an information processing system that is inspired by biological nervous systems, such as the brain. One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

Referring now to FIG. 4, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 302 that provide information to one or more “hidden” neurons 304. Connections 308 between the input neurons 302 and hidden neurons 304 are weighted, and these weighted inputs are then processed by the hidden neurons 304 according to some function in the hidden neurons 304. There can be any number of layers of hidden neurons 304, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 306 accepts and processes weighted input from the last set of hidden neurons 304.

This represents a “feed-forward” computation, where information propagates from input neurons 302 to the output neurons 306. Upon completion of a feed-forward computation, the output is compared to a desired output available from training data. The error relative to the training data is then processed in “backpropagation” computation, where the hidden neurons 304 and input neurons 302 receive information regarding the error propagating backward from the output neurons 306. Once the backward error propagation has been completed, weight updates are performed, with the weighted connections 308 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. The training data can be provided by the data that is stored in the historical training database. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight 308 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, the weights 308 may be implemented as resistive processing units (RPUs), generating a predictable current output when an input voltage is applied in accordance with a settable resistance.

The neural network can generate the input types of the variables of a given program. Mainly this model performs the task of given a program model generates input types of the program.

Program Analysis is a process by which behaviour of computer program can be analysed. This behaviour can be represented by various properties such as correctness, robustness, safety etc. Program analysis tool takes source code as input and can output various properties such as size, complexity, input variable name and it's types. It can be of two types (i) static program analysis and (ii) dynamic program analysis tool. Static program analysis tool can analyse the behaviour of a program without executing it. Dynamic program analysis tool captures characteristics of a program while it executes. Dynamic program analysis tool is used to capture the behaviour of a program by executing on different test cases. These tools use various techniques including control flow and data flow graph of a program.

Referring back to FIG. 2, following extracting the input variables and their types from the source code at block 1, the computer implemented method may continue to block 2, which includes extracting boundary conditions from the natural language constraints. Here the assumption can be that the implementation of the problem in programming language, e.g., JAVA, uses same variable name as the problem statement given in natural language description. Only variation, the variable names can be upper/lower case of english is permissible. In some embodiments, block 2 can include extracting the boundary condition of the variables. This can be achieved by Rule Based/Neural based/Prompt based method. The goal is to extract the boundary values (minimum and maximum value) of variables in the program from natural language constraints. In a neural based approach, there is a training dataset for a given a natural language constraint with corresponding boundary values of the variables, we can finetune a neural model (GPT based) which can generate the boundary values of the variables of a given natural language constraints. Mainly, this model performs the task of given a natural language constraint generates boundary values of the variables.

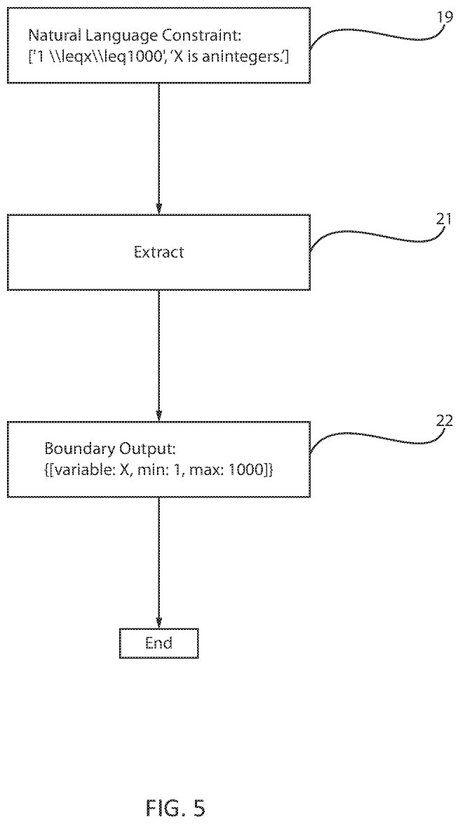

Then during test time, for a natural language constraint, the model will generate boundary values of the variables, as depicted in box 22 of FIG. 5.

In another example, a rules based approach is applied. In this example, natural language processing tools can be used to extract the variables and numeric maximum and minimum values of the variables. In this process certain rules are written to extract these boundary values of the variables. Using dependency parse tree and parts of speech tagging and grammar rules, relations among the words within the constraints are extracted to extract boundary values.

In another example, a prompt based approach is employed. For example, an artificial intelligence chatbot like large language model can perform various tasks given instructions of the task to be performed in natural language with or without few examples. In a similar way, the methods described herein extract boundary values of variables given constraints in natural language.

For example, referring to FIG. 5, a natural language constraint is illustrated at block 19. From the natural language constraint at block 19, the boundary constraints can be extracted at block 21, which results in the output at block 22. In this example, the output is {[variable:x, min:1, max:1000]}.

Referring back to FIG. 2, in a following step, a mapper at block may be employed to parse the outputs of blocks 1 and 2. A data mapper uses various software programs to extract data from a database, convert it, and load it into another database to analyze and glean insights into business analytics.

The function of mapper is to establish mapping between the variables coming from natural language (NL) parser and programming language (PL) parser. For example, variables ‘x’ and ‘y’ can be coming from PL parser and variables ‘X’ and ‘k’ can be coming from NL parser. The mapper can establish the correspondence between these 4 variables. For example, by writing certain rules, the mapper can set that variables ‘x’ and ‘X’ are referring to same variable, and can set it's boundary values are 1 and 1000. Similarly, the matter can set variables ‘y’ and ‘k’ to be referring to same variable and can set it's boundary values are 5.5 and 100.5.

More particularly, in one example, the mapper parses the output from extracting the input variables and their types from source code. More particularly, the mapper can scan through each variable from block 1. Mapper can establish mapping between variables coming from NL parser and PL parser.

Turning to the mapper application to the output of bock 2, the mapper parses the output from extracting boundary conditions from the natural language constraints of the source code. The mapper can scan through the JSON objects and extracts the boundary condition of each variable. A JSON object contains zero, one, or more key-value pairs, also called properties. The object is surrounded by braces { }.

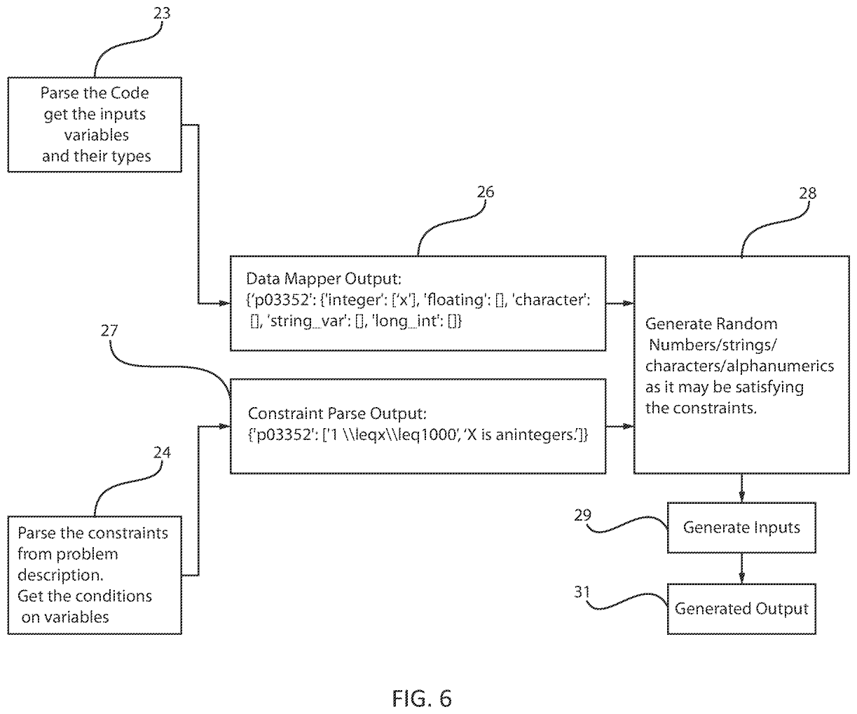

FIG. 6 is a flow/block diagram illustrating employing a mapper to parse the outputs from the step of extracting input variables and their types from the source code as illustrated in FIG. 3; and employing a mapper to parse the outputs from the step of extracting boundary conditions from natural language in FIG. 5, as well as input and output generation steps. More particularly, block 23 of FIG. 6 illustrates parsing the code to get the input variables and their types. This step is further described with reference to block 1 in FIG. 2. The output of this step is depicted in block 26 of FIG. 6.

Block 24 of FIG. 6 illustrates parsing the constraints from the problem description. This step represents the use of natural language descriptions in the code. This step is further described in block 2 of FIG. 2. The step obtains the conditions on the variables, and the output of the step is depicted in block 27 of FIG. 6.

Block 28 of FIG. 6 further illustrates the use of the mapper at block 3 of FIG. 2. The mapper can establish the mapping of variables between the two mappers steps, i.e., a first mapper step in which the mapper parses the output from extracting the input variables and their types from source code, and a second mapper step in which the mapper parses the output from extracting boundary conditions from the natural language constraints of the source code. In some embodiments, the mapper can establish the mapping of variables between the two mappers steps to generate random numbers for a variable depending upon if it's integer, float, string, etc. This mapping is established based on the matching in variables names. For example, the mapper can generate random numbers, strings, characters, alpha numerals as it may be satisfying the constraints. The mapper covers all branches of the code.

Referring back to FIG. 2, the computer implemented method may continue with input generation at block 4. In this step, a specified (user) number of random numbers/string/characters/alpha-numeric are generated for each variable within the boundary values. This step is illustrated in FIG. 6 as block 29.

Turning to block 5 of FIG. 2, the computer implemented method continues with output generation. In one embodiment, based on the input numbers generated in bock 4, the program is executed, and generated output is the final output. This step is illustrated in FIG. 6 as block 31.

The computer implemented method for automatically generating test cases satisfying constraints on program input specified via natural language that has been described herein is purely rule based. In this manner, it is explainable.

In the parsing modules of the computer implemented method described above, there is an embodiment that is purely based on programming language techniques, and therefore does not require heavy infrastructure in terms of GPUs. This is distinguishable from Large Language Models (LLMs). Therefore, cost of running the system provided by the presently described computer implemented methods, systems and computer program products is less than a comparable LLM.

The computer implemented method for automatically generating test cases satisfying constraints on program input specified via natural language is explainable and interpretable. For example, the proposed system uses PL parser to parse program and a natural language (NL) parser to parse natural language (NL) instruction.

The programming language (PL) parser is a module of compiler that extracts (abstract) tree structure of the program by which grammar rules of a program can be explained. The programming language (PL) parser takes the program as an input and can output different behavior/structure of the program. A Tree Sitter may be employed for parsing code to get the information about parent node, child node, code tokens, etc. By using the programming language (PL) parser meaningful information from the code can be extracted.

The natural language (NL) parser is a tool by which grammatical structure of natural language can be extracted. There is a concept in Natural Language Processing called a parse tree. The parse tree represents the structure of a natural language sentence. For a given sentence it represents which word is noun, verb, pronoun etc. in a sentence and how one word is related to another. By using natural language (NL) parser, meaningful information from any natural language sentence can be extracted.

As these parsed structures are the building blocks of the system, the system described herein is interpretable and explainable.

This computer. implemented methods, systems and computer program products can provide for automatic translation of computer programs from one programming language, e.g., COBOL, into another programming language, e.g., JAVA, for the purpose of application modernization so as the legacy applications can be migrated onto cloud computing environments, e.g., cloud computing servers.

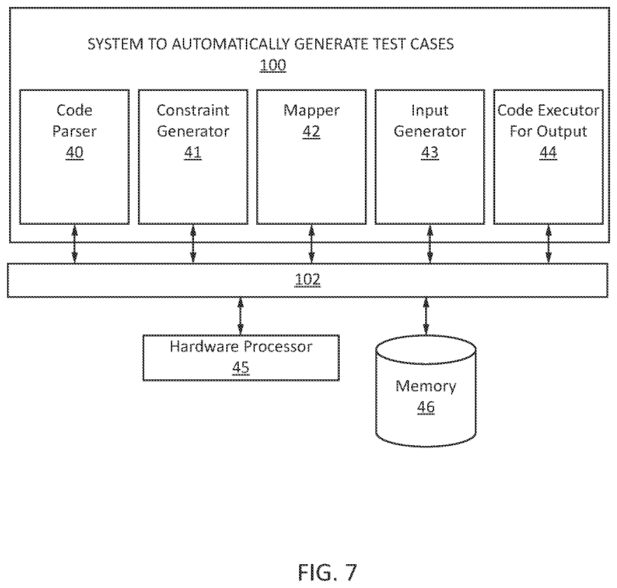

FIG. 7 is a flow/block diagram illustrating a system 100 for generating test cases satisfying constraints using natural language. The system depicted in FIG. 7 takes a natural language problem statement and a JAVA program as input and outputs ‘k’ number of input-output pairs. For example, the system 100 for generating test cases satisfying constraints that includes a hardware processor 45; and a memory 46 that stores a computer program product. The computer program product when executed by the hardware processor 45, causes the hardware processor 45 to parse source code to extract variables; and extract constraints from a natural language description in the source code to get boundary conditions on the variables. Referring to FIG. 7, the system 100 may include a code parser 40. The code parser 40 may perform the functions of block 1 of FIG. 2. The code parser 40 may perform the functions of FIG. 3. The system may also include a constraint generator 41. The constraint generator 41 extracts constraints from a natural language description in the source code to get boundary conditions on the variables. The constraint generator 41 may perform the functions of block 2 of FIG. 2. The constraint generator 41 may perform the functions of FIG. 5.

Referring back to FIG. 7, the system 100 may also include a mapper 42. The computer program product when employed by the system 100 may employ the mapper 42 to map between the variables extracted from the source code and the constraints from the natural language description. The mapper 42 can perform the functions of block 3 of FIG. 2, as well as block 28 of FIG. 6. Still referring to FIG. 7, the system 100 can also generate input variables satisfying the constraints provided from the natural language description; and execute the source code using the input variables satisfying the constraints provided from the natural language description. The input generator 43 can be used to generate input variables. The input generator 43 can perform the functions block 29 of FIG. 6. The code executor for output 44 can be used to execute the source code with the input variables produced by the input generator 43. The code executor for output 44 can perform the functions block 31 of FIG. 6.

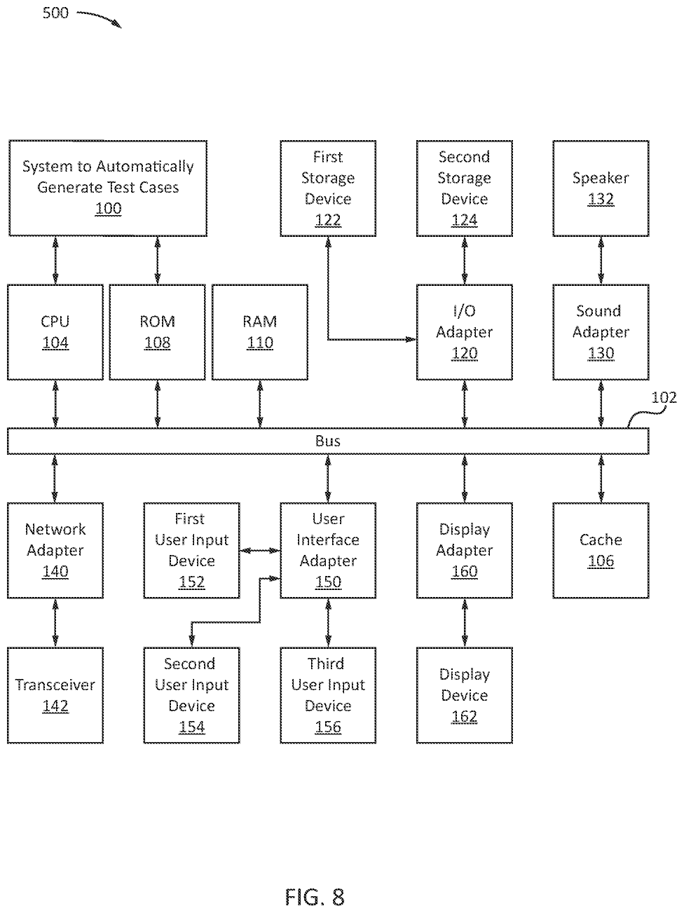

Referring to FIG. 7, in some embodiments, the components of the system for generating test cases satisfying constraints are interconnected by a bus 102. The bus 102 may also be in communication with at least one hardware processor 45 and memory 46, in which the hardware processor 45 and memory 46 may function with the other elements depicted in FIG. 7 to provide the functions described above. FIG. 8 further illustrates a processing system 500 that can include the system for generating test cases satisfying constraints that is described with reference to FIGS. 1-7. The exemplary processing system 500 to which the present invention may be applied is shown in accordance with one embodiment. The processing system 500 includes at least one processor (CPU) 104 operatively coupled to other components via a system bus 102. The system bus 102 may be in communication with the system 100. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102. As illustrated, the system 100 can be integrated into the processing system 500 by connection to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 400.

Of course, the processing system 500 may also include other elements (not shown), as readily contemplated by one of skill in the art, as well as omit certain elements. For example, various other input devices and/or output devices can be included in processing system 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 500 are readily contemplated by one of ordinary skill in the art given the teachings of the present invention provided herein.

The present invention may be a system, a method, and/or a computer program product at any possible technical detail level of integration. For example, in some embodiments, a computer program product is provided for dynamic pick and place operations using a robot. The computer program product can include a computer readable storage medium having computer readable program code embodied therewith. The program instructions executable by a processor to cause the processor to parse, using the hardware processor, source code to extract variables; and extract constraints from a natural language description in the source code to get boundary conditions on the variables. The program instructions can also map, using the hardware processor, between the variables extracted from the source code and the constraints from the natural language description; and generate input variables satisfying the constraints provided from the natural language description. The program instructions can also execute, using the hardware processor, the source code using the input variables satisfying the constraints provided from the natural language description.

The computer program product may include a computer readable storage medium (or media) having computer readable program instructions thereon for causing a processor to carry out aspects of the present invention. The computer program produce may also be non-transitory.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAS, and/or PLAs.

These and other variations of a hardware processor subsystem are also contemplated in accordance with embodiments of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing.

A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

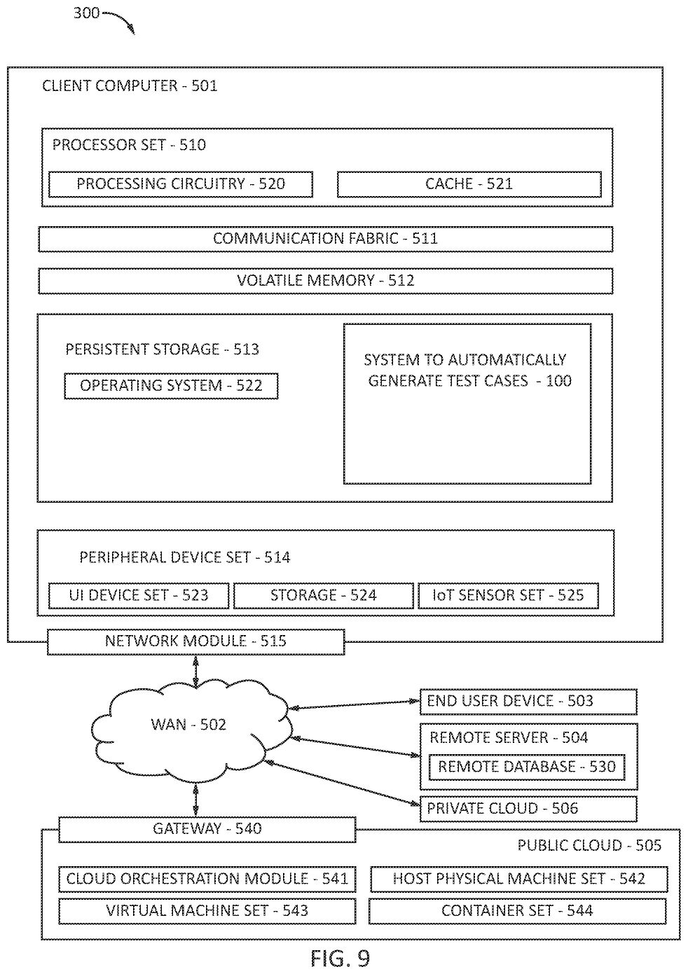

Referring to FIG. 9, the computing environment 300 contains an example of an environment for the execution of at least some of the computer code involved in performing the inventive methods, such as the method for dynamic pick and place operations using a robot 100. In addition to block 100, computing environment 300 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 100, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 501, to keep the presentation as simple as possible.

Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 300, at least some of the instructions for performing the inventive methods may be stored in block 200 in persistent storage 513.

COMMUNICATION FABRIC 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface type operating systems that employ a kernel. The code included in block 100 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 01 to communicate with other computers through WAN 102. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515. WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments,

EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method for generating test cases satisfying constraints using natural language (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer implemented method for generating test cases satisfying constraints comprising:
parsing source code to extract variables;
extracting constraints from a natural language description in the source code to get boundary conditions on the variables;
mapping between the variables extracted from the source code and the constraints from the natural language description;
generating input variables satisfying the constraints provided from the natural language description; and
executing the source code using the input variables satisfying the constraints provided from the natural language description.

2. The computer implemented method of claim 1, wherein the parsing of the source code to extract variables includes a rule based method.

3. The computer implemented method of claim 1, wherein the parsing of the source code to extract variables includes a program analysis method.

4. The computer implemented method of claim 1, wherein the parsing of the source code to extract variables includes a neural approach.

5. The computer implemented method of claim 1, wherein the extracting constraints from the natural language description in the source code to retrieve boundary conditions on the variables comprises a rule based method.

6. The computer implemented method of claim 1, wherein the extracting constraints from the natural language description in the source code to retrieve boundary conditions on the variables comprises a neural based approach.

7. The computer implemented method of claim 1, wherein the extracting constraints from the natural language description in the source code to retrieve boundary conditions on the variables comprises a prompt based approach.

8. The computer implemented method of claim 1, wherein the parsing the source code to extract variables also extracts types from the source code.

9. A system for generating test cases satisfying constraints comprising:
a hardware processor; and
a memory that stores a computer program product, the computer program product when executed by the hardware processor, causes the hardware processor to:
parse source code to extract variables;
extract constraints from a natural language description in the source code to retrieve boundary conditions on the variables;
map between the variables extracted from the source code and the constraints from the natural language description;
generate input variables satisfying the constraints provided from the natural language description; and
execute the source code using the input variables satisfying the constraints provided from the natural language description.

10. The system of claim 9, wherein the parsing of the source code to extract variables includes a rule based method.

11. The system of claim 9, wherein the parsing of the source code to extract variables includes a program analysis method.

12. The system of claim 9, wherein the parsing of the source code to extract variables includes a neural approach method.

13. The system of claim 9, wherein the extracting constraints from the natural language description in the source code to retrieve boundary conditions on the variables comprises a rule based method.

14. The system of claim 9, wherein the extracting constraints from the natural language description in the source code to retrieve boundary conditions on the variables comprises a neural approach method.

15. The system of claim 9, wherein the extracting constraints from the natural language description in the source code to retrieve boundary conditions on the variables comprises a prompt based approach.

16. The system of claim 9, wherein the parsing the source code to extract variables also extracts types from the source code.

17. A computer program product for picking and placing operations for generating test cases satisfying constraints, the computer program product can include a computer readable storage medium having computer readable program code embodied therewith, the program instructions executable by a hardware processor to cause the hardware processor to:
parsing, using the hardware processor, source code to extract variables;
extract, using the hardware processor, constraints from a natural language description in the source code to retrieve boundary conditions on the variables;
map, using the hardware processor, between the variables extracted from the source code and the constraints from the natural language description;
generate, using the hardware processor, input variables satisfying the constraints provided from the natural language description;
execute, using the hardware processor, the source code using the input variables satisfying the constraints provided from the natural language description.

18. The computer program product of claim 17, wherein the parsing of the source code to extract variables includes a rule based method.

19. The computer program product of claim 17, wherein the parsing of the source code to extract variables includes a program analysis method.

20. The computer program product of claim 17, wherein the parsing of the source code to extract variables includes a neural based approach.
